(19) United States
(12) Patent Application Publication
(10) Pub. No.: US 2010/0103820 A1
(43) Pub. Date: Apr. 29, 2010

(54) FAIR USE MANAGEMENT METHOD AND SYSTEM

(75) Inventors: Randy FULLER, Wellesley, MA (US); Robert JACKSON, Marlborough, MA (US); Yusun Kim RILEY, Marlborough, MA (US)

Correspondence Address: WILMERHALE/BOSTON, 60 STATE STREET, BOSTON, MA, 02109, US

(73) Assignee: Camiant, Inc., Marlborough, MA (US)

(21) Appl. No.: 12/473,606

(22) Filed: May 28, 2009

Related U.S. Application Data
(60) Provisional application No. 61/056,674, filed on May 28, 2008.

(51) Int. Cl. H04L 1/00

(52) U.S. Cl. 370/236

(57) ABSTRACT

A method of managing a plurality of subscribers using a communication network involving: obtaining network usage data for a plurality of service flows associated with the plurality of subscribers using the network; from the network usage data, determining which of the plurality of subscribers has been using an excess amount of bandwidth; determining that at least some part of the network is currently in a congested state; and in response to determining that at least some part of the network is currently in the congested state, sending a policy decision to a gateway device that controls bandwidth resources currently being provided to the identified subscriber, said policy decision instructing the gateway device to reduce network bandwidth that is currently being provided to support existing service flows for the identified subscriber.

This application claims the benefit of U.S. Provisional Application No. 60/056,674, filed May 28, 2008, all of which is incorporated herein by reference.

### TECHNICAL FIELD

This invention relates generally to the field of networking and particularly to managing networks.

### BACKGROUND OF THE INVENTION

Network operators have many decision points to go through in determining how best to allocate limited capital resources to the task of assuring competitively robust broadband services in the years ahead. Continuing a trend that's been in force for several years, Multiple System Operators (MSOs) are now expanding downstream throughput into the ten-plus megabits-per-second (mbps) range, with some going to 20 mbps or higher, especially in areas where they're competing with all-fiber-based broadband services. Furthermore, most MSOs have migration strategies tied to the bonded channel capabilities of DOCSIS 3.0, with plans to begin offering 50, 100 or higher mbps services over the next few years.

With such aggressive bandwidth expansion in play, it might be tempting to look on these steps as sufficient to ongoing capacity requirements, obviating the need to spend additional sums on bandwidth management solutions. But such an approach actually risks spending more, not less than would be necessary if adequate bandwidth management solutions were deployed early.

### SUMMARY OF THE INVENTION

In general in one aspect the invention features a method of managing a plurality of subscribers using a communication network. The method involves: obtaining network usage data for a plurality of service flows associated with the plurality of subscribers using the network; from the network usage data, determining which of the plurality of subscribers has been using an excess amount of bandwidth; determining that at least some part of the network is currently in a congested state; and in response to determining that at least some part of the network is currently in the congested state, sending a policy decision to a gateway device that controls bandwidth resources currently being provided to the identified subscriber, said policy decision instructing the gateway device to reduce network bandwidth that is currently being provided to support existing service flows for the identified subscriber.

In general, in another aspect the invention features a system for managing a communication network having a plurality of devices through which a plurality of subscribers connect to the network, one or more monitoring devices for measuring network usage data for the plurality of subscribers, and a gateway device for controlling network bandwidth resources that are made available to each of the subscribers. The system includes: a policy server that instructs the control device regarding what bandwidth is made available to each of the plurality of subscribers; an analysis module configured to: (1) obtain usage data for a plurality of service flows associated with the plurality of subscribers using the network; (2) from the network usage data, determine which of the plurality of subscribers has been using an excess amount of bandwidth; (3) determine that at least some part of the network is currently in a congested state; and (4) notify the policy server of the congested state, wherein the policy sever is programmed to respond to the notification from the analysis module by instructing the gateway device to reduce network bandwidth that is currently being provided to support existing service flows for the identified subscriber.

Other embodiments include one or more of the following features. Determining that at least some part of the network is in a congested state involves: (1) receiving a notification from another entity on the network that said at least some part of the network is in the congested state; or (2) analyzing the network usage data for the plurality of service flows; or (3) determining that current time falls within a predefined period of time. The network is a cable network including a plurality of cable modem termination systems (CMTSs) and sending the policy decision to the gateway device involves sending the policy decision to one of the plurality of CMTSs. Alternatively, the network is a mobile network. The policy decision instructing the gateway device to reduce network bandwidth that is being provided to the identified subscriber instructs the gateway device to reduce only the network bandwidth that is being provided to specified applications being currently used by the identified subscriber. Determining which of the plurality of subscribers is using an excess amount of bandwidth for at least some part of the network involves examining usage by that subscriber over an extended period of time. Determining which of the plurality of subscribers is using an excess amount of bandwidth for at least some part of the network involves referencing a database which identifies subscribers which have been using excess bandwidth.

A robust bandwidth management solution, such as the fair use management approach described herein, prevents the high-volume users from degrading the experiences of average users. This can reduce the number of Cable Modem Termination System (CMTS) ports that are required to maintain any given level of service across any given size service area. Network management techniques such as this also allow operators to minimize the number of node splits required to maintain consistent service performance.

A robust bandwidth management solution makes it possible to achieve cost savings on the backbone portion of the network as well. Implementing higher speed service flows over the access portion of the network results in aggregate higher volume service flows over the backbone, which has implications for backbone infrastructure capacity and routing requirements as well as the costs of peering the cable broadband network with other networks.

Not having a bandwidth management system in place can be especially damaging with respect to the impact congestion has on an operator's high-value customers who subscribe to business or top-end service tiers. In a best-effort environment, the highest speed tiers are most affected when excessive use by a few squeezes bandwidth availability. While basic tier users accustomed to receiving services at one or more mbps might experience no significant difference in their access speeds, those who are subscribing to a 10 mbps tier may find they are getting nothing better than the basic tier subscribers.

Furthermore, experience shows that no matter how much a service provider expands broadband capacity, users will consume the bandwidth. The combination of rising volumes of streamed video, especially long-form programming, ever more P2P usage and increasing numbers of Web media users in the home portends insatiable demand for more bandwidth at peak periods than can be reasonably accommodated by bandwidth capacity expansion alone.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 shows a block diagram of a cable network in which a fair use management approach is implemented.

### DETAILED DESCRIPTION

The fair use management approach described herein applies sophisticated policy management techniques to establish and enforce bandwidth quotas. The process focuses on individual service flows to determine where excessive use is causing problems. A service flow corresponds to the “virtual pipe” between the subscriber's equipment, such as a PC, and the access gateway which functions as the terminating entity of the broadband service over the access network. It is typically associated with a particular application. Thus a subscriber can have multiple service flows, each for a different application or application server. In the cable network, the access gateway would be the Cable Modem Termination System (CMTS) and the access network would be the DOCSIS network. An operator sets a policy as to what the bandwidth quota for individual usage at any given tier of service should be and determines what actions, if any, should be taken when users go beyond their quotas during times of network congestion.

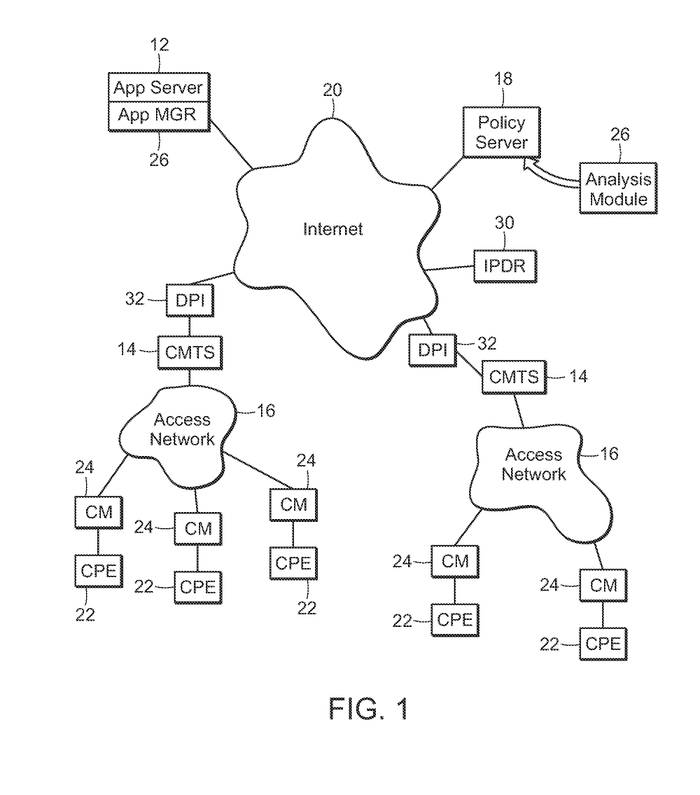

FIG. 1 is a high level diagram of an architecture for delivering multimedia sessions over a cable network with Quality of Service. This particular embodiment will be used to explain the fair use management approach described herein. However, it should be understood that the fair use management approach is not limited to use only in cable networks but can be employed or implemented generally in other types of networks, including fixed networks, mobile networks, and combinations of both.

The particular embodiment of FIG. 1 includes an application server (AS) 12; an application manager (AM) 26, multiple Cable Modem Termination Systems (CMTSs) 14, which function as gateways to one or more access networks 16; and a policy server (PS) 18, which manages admission control and Quality of Service on behalf of application server 12. These elements are typically connected to a network 20 (e.g. the Internet) over which they are able to communicate with each other. Customer Premises Equipment (CPE) 22, such as personal computers (PCs), game consoles, or set top boxes (STBs), are connected to the access networks 16 through Cable Modems (CM) 24. The network also includes an IPDR (Internet Protocol Detail Records) collector 30 and DPI (Deep Packet Inspection) boxes 32, which are used to gather or extract data and information about subscriber network usage and data flows. IPDR collectors collect per subscriber or service flow usage data from the CMTSs. DPIs are devices that sit in the path of the data in the network and can inspect individual packets, as well as track usage per subscriber.

There are two other functions that are of particular importance to the fair use management capabilities and in the described embodiment, those functions are contained within policy server 18. One function is provided by an analysis and notification module 36 which obtains data from IPDR collector 30 and/or DPI boxes 32 and analyzes the data flows and usage information to identify the users who use the most amount of resources in the network, analyzes the aggregate usage information of subscribers, associates the overall usage with specific nodes in the network (example, all usage associated with a particular downstream or upstream DOCSIS channel, or similarly in a mobile network, a cell site) to determine when a particular node may be experiencing heavy loads of traffic (i.e., congested), and provides notification of this. The other function is represented by certain core capabilities of policy server 18 which enable it to dynamically change the policies (e.g. QoS/bandwidth tier) being applied to the sessions or data flows of the heavy users. As will be described in greater detail below, this functionality determines when congestion occurs within the network, identifies the heavy use subscribers (e.g. subscribers using bandwidth beyond their quotas), and causes the appropriate network devices to dynamically throttle back on the bandwidth that is made available to the subscribers who are or have been using the most resources. Again, it should be understood that the analysis and notification module is a logical function that need not reside in policy server 18. Such logic can be implemented in another separate device on the network.

Before discussing the fair use management functionality, the general operation of this particular network will first be described.

In general, application server 12 requests application sessions with identified subscribers. These requests go to policy server 18, which evaluates them and either approves or denies them, depending on availability of network resources and policies or rules that are available to the policy server. If the request is approved, policy server 18 instructs the appropriate CMTS 14 behind which the cable modem for that subscriber is located to create a dynamic flow with specific QoS and bandwidth attributes over which the traffic will flow. When the session is terminated or ends, the application informs policy server 18 and the policy server tears down the flows at the CMTS.

The CMTS, which is a device that sits at a cable head-end, functions as a data switching system designed to route data to and from many cable modem users over a multiplexed network interface. It integrates upstream and downstream communications over the access networks (e.g. a cable data network) to which it is connected.

Application server 12, which is managed by a content provider, is the entity that delivers the content to the applications on CPEs 22 connected to cable modems 24. On the Internet, common examples of such servers include the Yahoo web server; file upload servers; video servers; Xbox servers, etc. Application manager 26 provides application server 12 with an interface to policy server 18 through which application server 12 requests QoS-based service on behalf of an end-user or network management system. Typically, application manager 26 is implemented as part of application server 12, as indicated, but this need not be the case.

Cable modems 24 enable other Customer Premises Equipment (CPE) 22 which is operated by subscribers to connect to access network 16 and receive cable services.

Policy server 18 is a system that primarily acts as an intermediary between application manager 26 and CMTS(s) 14. It generally manages the operation of the CMTSs by applying network policies to requests from the application managers, and proxies messages between the application manager and CMTSs. In the described embodiment, it implements the functionality that is specified by DOCSIS (DOCSIS refers to the set of Data-Over-Cable Service Interface Specifications, which defines how to transmit data over cable networks in a standard fashion) and the Packet Cable Multimedia (PCMM) standards (e.g. see PacketCable Multimedia Architecture Framework Technical Report PKT-TR-ARCH-V01-030627) to send messages to the network components (e.g. CMTSs) that control bandwidth and service flows. In its capacity as an intermediary, policy server 18 grants QoS for different requesters based on policy rules established by the operator of the network or service, and affects the QoS by pushing down policy decisions to the termination devices (e.g. the CMTSs). It also has extended functionality that includes keeping track of and monitoring the state of the network (what is happening on the network, the state of the sessions, etc.) and making policy decisions based on the state of the network.

The mechanisms employed in the network to achieve the fair use management approach described herein fulfill five basic requirements. These will now be described.

### Collection of Usage Data

There are two primary mechanisms presented in the architecture of FIG. 1 for operators to use in identifying how much bandwidth each broadband customer is consuming over time: Internet Protocol Detail Records (IPDR) and Deep Packet Inspection (DPI). In the described embodiment, collection module 34 within policy server 18 receives usage data from at least one of these sources (i.e., IPDR collector 30 and DPI boxes 32). In the case of the IPDR collector 30, the CMTS periodically reports usage data via IPDR records to the IPDR collector and it should be noted that the IPDR records also indicates the DOCSIS channel associated with the particular subscriber's data flow and which can be used to associate all the subscriber's traffic with a particular channel and to determine when a particular channel may be experiencing congestion.

In the case of the DPI system, the analysis and notification functions could receive usage information from the DPI in a very similar manner to the IPDR records from the CMTS, or alternatively, the DPI can also be programmed to report information to the policy server directly, if individual subscribers' sessions exceed usage; such thresholds are internal mechanisms that are provisioned on the DPI.

Beginning with DOCSIS 1.1 CMTSs have been equipped to accumulate network data (IPDR records) regarding the performance of individual service flows between the CMTS and cable modems using the IPDR Streaming Protocol and developed by the IPDR Organization, a pan-industry group. The information provided by the IPDR records is the subscriber, flow, topology data, and byte count. IPDR data is based on flows, but it can be aggregated to create subscriber related data. IPDR collector 30 collects the IPDR records containing the IPDR data from the various CMTSs. This can be achieved by having the CMTSs periodically report usage via IPDR records to an external IPDR collector.

To support a fair use management application, IPDRs are an excellent data source, in particular providing highly granular detail about what is happening for all flows, including dropped/delayed packets as a direct indicator of network congestion. IPDR systems are commercially available from companies like Applied Broadband. These systems receive messages in a protocol and format described by the IPDR working group about which more information is available at IPDR.org.

Deep Packet Inspection (DPI) is a term used for “wire sniffing” systems that can view each packet that is transmitted and received across the network. While DPI is not a component of DOCSIS or PacketCable, DPI is used in cable operations for identifying viruses, tracking usage patterns and various other applications associated with the ability to read and collect data. Commercially available proprietary DPI systems can also be used as the data collection points to monitor usage per subscriber in support of the fair use management solution described herein.

DPI boxes are commercially available from various manufacturers including Cisco, Allot, and Procera.

It should be noted that IPDR systems are purely based on overall usage associated with the subscriber. The usage data is not broken down into applications. In contrast, the DPI systems are capable of tracking usage on a per application basis—for example, a specific VoIP session, or a P2P session associated with a particular subscriber—the control mechanisms discussed below can be used to throttle subscribers when they have used “too much” of a specific type of application.

### Analysis of Usage Data

Analysis module 36 analyzes the data from collection module 34 to identify when congestion exists, to determine how much bandwidth each subscriber is using, and to then notify other functions in policy server 18 when the triggering of policy decisions is appropriate. Various different methods from the very simple to the more complicated can be used to detect congestion from available usage data and to identify the top users (e.g. the subscribers exceeding their quotas of allotted bandwidth).

An example of a simple approach to recognizing congestion is detecting when total usage exceeds a predefined threshold for the access network or port of a gateway device. A simple method for recognizing and culling out these congestion-inducing usage patterns is to identify which users are exceeding their quotas over a given time period. Typical approaches might be focused on long-term consumption such a monthly byte cap, on shorter-term consumption peaks to address temporary congestion, or a combination of both. In that case, the collected data is used to figure out which subscribers have used more than a certain amount of data over a certain time period. This can operator configurable by setting thresholds defining what is meant by “use too much”. For example, the operator can define the usage limit as 5 gigs per month. If the overall usage of data exceeds 5 gigs per month, then that subscriber may be subject to throttling, during busy times in the network, or when the network is deemed to be congested.

Alternatively, instead of analyzing the usage data, analysis module 36 can simply rely on other devices in the network to make that determination and provide it to the analysis logic. For example, in a mobile network the RAN (Radio Access Network) often has knowledge of when it is congested. Logic module 36 can rely on that knowledge to determine when congestion exists rather than making an independent determination. Also, termination devices or gateways can be programmed to detect when congestion exists based on internal criteria. These external systems can provide information to the policy server so the policy server can use the information about the current state of the network in order to make decisions on whether to throttle the heavy users or not.

Still another way to determine congestion is to define preconfigured time periods as periods of congestion and apply the mitigation polices during those preconfigured time periods. This would be appropriate if, for example, the network operator knows through experience that during certain periods of the day (or the week or the month or the year) congestion occurs with a high probability.

The analyzer can also correlate the usage data according to the physical topology. The IPDR data also indicates the DOCSIS channel associated with the particular subscriber's data flow. The analyzer can associated all the subscribers' traffic associated with a particular channel, and use this to determine when a particular channel may be experiencing congestion.

There are other means of determining congestion that are under investigation by various vendors and that could be used to perform more sophisticated analysis, such as ways to predict where and when congestion will occur. Such techniques if employed enable the fair use management solution described herein to take remedial action as soon as necessary. Whatever means are employed, it is desirable that they be flexible enough to accommodate adjustments when usage trends dictate a change in the analytical parameters.

### Trigger Policy Decision

Once a point of congestion and the excess users are identified, the analysis module 36 notifies policy server 18 about both the congestion and the identity of the heavy users. In embodiments, in which the analysis module is separate from the policy server, the standard PCMM interface can be used to accomplish this communication. Alternatively, another interface could be used, e.g. a simplified Web service interface.

### Evaluate Control Policies

The evaluation of control policies, along with the enforcement mechanism described below, is the fair use management functionality that is intrinsic to the role of the policy server in the PCMM architecture. A platform such as a globally deployed policy server typically is used to apply rules governing bandwidth prioritization for assuring Quality of Service (QoS) associated with certain applications and services. It can also easily be used to communicate bandwidth adjustment messages to network components in accord with whatever rules an operator chooses for addressing congestion issues.

Use of a rules engine inside policy server 18 allows operators to set and modify fair use management policies as they see fit. They can set treatment categories in accord with user tiers, time of day, level of congestion and other parameters. When it comes to users whose usage patterns dictate that they be controlled, operators can set a wide range of rules as to whether, and to what degree, actions are implemented.

For example, depending on the degree of congestion, degree of excess usage or other parameter, the rule might trigger different percentages or time periods where a particular user's bandwidth should be managed. Or the rules might be set to avoid any throttling action so long as the excess use is not degrading other users' throughput.

### Enforce the Control Policy

Once it is determined that a control is required under the fair management rules, the policy server communicates the command to the CMTS. The flexibility of PCMM, allows the controlling mechanisms to be applied across a number of DOCSIS parameters by setting bandwidth priorities, imposing caps or directly controlling a specific user's bandwidth for a given amount of time, in either the upstream or downstream directions, or in both directions.

In a typical fair use management strategy, an operator would clearly convey usage policies to customers with a declaration that if the user consumes more than X amount of bandwidth over a given amount of time, the operator reserves the right to take action. The operator, using the herein described policy management mechanisms intrinsic to the PCMM specifications, has great flexibility on a case-by-case basis as to what, if any, actions need to be taken in instances where quotas are exceeded.

For example, if the operator only wants the solution to control a user's throughput when excess usage is seen to be affecting other users' experiences, the policy can be set to take action only when a given service area is congested. Alternatively, the fair use management application can be set to control an over-quota user's throughput through a set period of time or just at a particular time of day.

Though the sources of usage data identified above were an IPDR system and a DPI box, there are other sources from which such data could be collected. For example, it could be collected from another entity that is gathering IPDR records. In other networks, it can be collected from access gateways or from backend OSS (Operational Support Systems), to name just two example.

It should be pointed out that even though IPDR and DPI mentioned above provide near real-time means of identifying points of congestion and identifying which service flows are the biggest contributors to that congestion, an alternative, more rigorous approach to monitoring and controlling service flows is a solution intrinsic to the PacketCable Multimedia specifications. In this alternative approach, dynamic service flows prescribing user-specific data rates are created for each subscriber in lieu of the default service flows defined by the modem configuration file. These flows are then used to dynamically adjust the subscriber's data rate on demand, and provide proactive volume-based notification for instant service adjustments. For operators who want to exploit the full benefits of PCMM, this mechanism provides the most directly responsive, real-time means of applying and enforcing usage policies on a per-user basis.

More specifically, in this alternative mechanism, instead of using interim usage records (e.g. RADIUS, IPDR) to gather usage data and then determine whether a subscriber has exceeded its limit, the policy server can actually set a limit on the gateway, the gateway counts the bytes, and when the usage exceeds the limit set by the policy server, the gateway notifies the policy server. This mechanism is more “real time” in that it enables the policy server to react more quickly to overall usage conditions. Still another mechanism that can be used for mobile access involves using the diameter protocol accounting messages to accumulate usage, then do the analysis when the usage is exceeded to trigger policy action. The diameter accounting mechanism in mobile would be similar to the IPDR method described above in cable.

As noted above, the fair use management approach can be implemented in other networks, both fixed and mobile. In such other networks, different gateway type devices perform the policy enforcement functions of the CMTS. For example, in a mobile network, it might be a gateway GPRS support node (GGSN) or a packet data serving node (PDSN); and in another type of fixed network, it might be a broadband remote access server (B-RAS).

These various devices function as gateways, all of which are capable of generating usage records. GGSNs, PDSN or Home Agents (in mobile networks) and B-RAS (Broadband Remote Access Servers in fixed/DSL networks) and CMTSs in cable networks generate records. In mobile networks, records are typically generated using the RADIUS or Diameter protocols. In fixed networks, RADIUS is typically used. In cable networks, as discussed above, IPDR records are generated. In all of these types of networks, the usage information can be analyzed either by a function within the policy server or by a function located elsewhere in the network to determine who the heavy users are. Once the determination is made, if the analyzer is within the policy server, it will notify the policy server of the heavy users internally. If external to the policy server, it will signal to the policy server the subscribers who are determined to be heavy users. And that information can be stored in an internal database for use when congestion is detected. The policy server makes the determination of whether to throttle the subscriber or not, based on the state of the network (i.e., whether it is deemed to be congested or not).

By using long term information, such as usage over a month period, as well as any other information about the subscriber, such as their tier (premium, vs. best effort), the policy server can make intelligent decisions about who to throttle, and when. Congestion relief algorithms can sometimes be found locally inside the access gateways themselves, or in the case of the RAN, in the radio network itself. However, these mechanisms do not take a long term perspective on the individual subscriber's overall usage in order to make on the spot decisions about which packets to keep and which to drop. The advantage of the fair use management approach described herein is that individual subscriber's long term usage information, as well as other information such as the subscriber's tier, as well as other constructs such as busy times of the day, can be taken into account when making a decision to dynamically change the bandwidth and QoS attributes of a subscriber's session.

In the described embodiment, bandwidth quotas were used to trigger enforcement. However, the average speed over time could also be used as a trigger for enforcement. And enforcement options could include reducing subscriber speed, adjusting the quota, or even locking the subscriber into a “walled garden” where they could view their account information but not access the open interne.

It should also be understood that the functionality described herein (such as the policy server, the data collection functions, and the analysis and notification functions) can be implemented by software running on a computer system. Such a computer system would typically include computer readable medium storing the code for the relevant functionality and one or more processors on which that code is executed to implement the functionality.

Other embodiments are within the following claims.

What is claimed is:

1. A method of managing a plurality of subscribers using a communication network, said method comprising:
obtaining network usage data for a plurality of service flows associated with the plurality of subscribers using the network;
from the network usage data, determining which of the plurality of subscribers has been using an excess amount of bandwidth;
determining that at least some part of the network is currently in a congested state; and
in response to determining that at least some part of the network is currently in the congested state, sending a policy decision to a gateway device that controls bandwidth resources currently being provided to the identified subscriber, said policy decision instructing the gateway device to reduce network bandwidth that is currently being provided to support existing service flows for the identified subscriber.

2. The method of claim 1, wherein determining that at least some part of the network is in a congested state involves receiving a notification from another entity on the network that said at least some part of the network is in the congested state.

3. The method of claim 1, wherein determining that at least some part of the network is in a congested state involves analyzing the network usage data for the plurality of service flows.

4. The method of claim 1, wherein determining that at least some part of the network is in a congested state involves determining that current time falls within a predefined period of time.

5. The method of claim 1, wherein network is a cable network including a plurality of cable modem termination systems (CMTSs) and wherein sending the policy decision to the gateway device involves sending the policy decision to one of the plurality of CMTSs.

6. The method of claim 1, wherein network is a mobile network.

7. The method of claim 1, wherein said policy decision instructing the gateway device to reduce network bandwidth that is being provided to the identified subscriber instructs the gateway device to reduce only the network bandwidth that is being provided to specified applications being currently used by the identified subscriber.

8. The method of claim 1, wherein determining which of the plurality of subscribers is using an excess amount of bandwidth for said at least some part of the network involves examining usage by that subscriber over an extended period of time.

9. The method of claim 1, wherein determining which of the plurality of subscribers is using an excess amount of bandwidth for said at least some part of the network involves referencing a database which identifies subscribers which have been using excess bandwidth.

10. A system for managing a communication network having a plurality of devices through which a plurality of subscribers connect to the network, one or more monitoring devices for measuring network usage data for the plurality of subscribers, and a gateway device for controlling network bandwidth resources that are made available to each of the subscribers, said system comprising:
a policy server that instructs the control device regarding what bandwidth is made available to each of the plurality of subscribers;
an analysis module configured to: (1) obtain usage data for a plurality of service flows associated with the plurality of subscribers using the network; (2) from the network usage data, determine which of the plurality of subscribers has been using an excess amount of bandwidth; (3) determine that at least some part of the network is currently in a congested state; and (4) notify the policy server of the congested state,
wherein the policy sever is programmed to respond to the notification from the analysis module by instructing the gateway device to reduce network bandwidth that is currently being provided to support existing service flows for the identified subscriber.

11. The system of claim 10, wherein the analysis module is configured to determine that at least some part of the network is in a congested state by receiving a notification from another entity on the network that said at least some part of the network is in the congested state.

12. The system of claim 10, wherein the analysis module is configured to determine that at least some part of the network is in a congested state by analyzing the network usage data for the plurality of service flows.

13. The system of claim 10, wherein the analysis module is configured to determine that at least some part of the network is in a congested state by determining that current time falls within a predefined period of time.

14. The system of claim 10, wherein network is a cable network including a plurality of cable modem termination systems (CMTSs) and wherein the gateway device is one of the plurality of CMTSs.

15. The system of claim 10, wherein network is a mobile network.

16. The system of claim 10, wherein said policy decision instructing the gateway device to reduce network bandwidth that is being provided to the identified subscriber instructs the gateway device to reduce only the network bandwidth that is being provided to specified applications being currently used by the identified subscriber.

17. The system of claim 10, wherein determining which of the plurality of subscribers is using an excess amount of bandwidth for said at least some part of the network involves examining usage by that subscriber over an extended period of time.

18. The system of claim 10, wherein determining which of the plurality of subscribers is using an excess amount of bandwidth for said at least some part of the network involves referencing a database which identifies subscribers which have been using excess bandwidth.
